(19) United States
(12) Patent Application Publication
(10) Pub. No.: US 2007/0248887 A1
(43) Pub. Date: Oct. 25, 2007

(54) Using metal foam to make high-performance, low-cost lithium batteries

(75) Inventors: Michael David Eskra, Saukville, WI (US); Paula Margaret Ralston, Danbury, CT (US)

Correspondence Address: Edward G. Durney;Patent Strategies, 11 Rosalita Lane, Millbrae, CA, 94030, US

(73) Assignee: Eskra Technical Products, Inc.

(21) Appl. No.: 11/408,856

(22) Filed: Apr. 21, 2006

(51) Int. Cl. H01M 4/80

(52) U.S. Cl. 429/235; 29/623.1

(57) ABSTRACT

New wireless devices need better batteries, more powerful but still low cost. We have created one—a high-performance lithium-based battery using metal foam (or some other three-dimensional, fillable, conductive material) to make its electrodes. Our battery offers as much as 30% to 100% greater power and energy density. Similar increases in power and energy density typically increase costs tens or hundreds of times. Our increased performance adds no extra cost. Metal foam increases conductivity within the electrode. So electrodes can be made much thicker, but no more resistant. Thicker electrodes bring more power and more energy for the same volume and weight. Our high-performance, low-cost batteries can be used for small wireless devices like smart cards, for larger mobile devices like cell-phones, and even the high-power, high-energy batteries needed for cars. At all sizes, we provide more power and energy at the same cost.

### FIELD OF INVENTION

We have invented a high-performance lithium-based battery with metal foam (or some other three-dimensional, fillable, conductive material) in its electrodes.

### TABLE OF CONTENTS

A. INTRODUCTION

B. THE PROBLEM, THE SOLUTION AND THE RESULT

1. The Problem—Thicker Electrodes Would Be Better, But Now Perform Poorly
a. Thicker Electrodes Currently Have Lower Power and Energy Density
b. Thicker Electrodes Bring Higher Resistance
c. Thicker Electrodes Hard to Make

2. The Solution—Metal Foam (or Other 3D Material) Allows Thicker Electrode
a. Metal Foam Allows Thicker Electrode, Bringing Higher Power and Energy Density
b. Metal Foam Prevents Increased Resistance

3. The Result—Batteries With Higher Power and Energy Density and Lower Cost

C. THE DRAWINGS

D. DETAILED SPECIFICATIONS ON HOW TO MAKE BATTERIES WITH ELECTRODES WITH THREE-DIMENSIONAL, FILLABLE MATERIAL
Example A: A Battery With Metal Foam Electrodes
Example B: A Battery With Metal Cloth Electrodes
Example C: A Battery With Perforated Foil Electrodes

### INTRODUCTION

We have invented a way to use metal foam to make high-performance lithium-based batteries at low cost. For the most part, we describe how to use metal foam to make these batteries. But metal cloth—or any other conductive material with open cells that can be filled with active material—will also work to make batteries perform better.

Why is that important? We need powerful, high energy, long life, low cost batteries. Consumers use more and more wireless electronic devices. Most people regularly use cell phones, music players, laptop computers, portable game systems, and remote controls. Hybrid and electric vehicles require batteries with very high power and energy. Batteries power all these systems.

Even gasoline-powered cars have become more electric. The cost of the electronics in today's cars can be as much as 20% to 30% of the total cost of the car. As hybrid cars become popular, the cost can increase to 50%. And cars cannot be plugged into the electric power grid—they need to run on power from batteries.

But batteries have always been a problem. From electric cars to cell phones, batteries have kept portable electronic devices from performing up to their potential. Why? Because of the size and weight of batteries, the limited power they can provide, and their high cost.

Constant efforts have been made to improve battery performance. In particular, new chemistries—such as lithium-ion and other lithium chemistries—have become popular. Increased power and energy have been the result.

But more power and more energy usually means higher cost. And even the best improvements in performance are usually incremental—maybe 2 or 3% better. Few new battery technologies offer dramatically better power and energy density at the same or reduced cost.

Our invention does. By using metal foam—or other three-dimensional, open-cell, fillable material—we can offer 30% to 100% greater power and energy density, without added cost.

### THE PROBLEM, THE SOLUTION AND THE RESULT

1. The Problem—Thicker Electrodes Would Be Better, But Now Perform Poorly

Higher power and energy density mean a better battery. Take the example of a hybrid electric car. When the car accelerates, its electric motor needs a lot of power from the battery all at once. Batteries with higher power density can provide this power surge. For energy density, the total amount of energy the battery can store is important. A car with a battery with higher energy density can go farther.

And in an electric car (even hybrids), braking can often be used to generate electricity. Higher power density lets the battery be recharged quicker, handling higher currents. Conventional high-energy batteries do not accept high recharge rates without damaging the battery or vehicle.

There are several ways to improve the energy and power density of a battery. One way is to use a different chemistry. For example, nickel-cadmium batteries have higher energy density than lead-acid batteries. Lithium-ion batteries owe most of their popularity to the fact that they offer the highest energy densities among the common battery chemistries.

But even after the choice of chemistry is made, some things can be done to improve power and energy densities. And any technology that increases power and energy density will be welcome, particularly if it comes at a reasonable cost. Our invention dramatically increases the energy density and power density of lithium-based batteries, at little increased cost.

Our invention does this by increasing the thickness of one or both of a battery's electrodes. By using this material, and increasing the thickness of the battery electrodes, our invention helps unleash the innate power of the lithium-based chemistry.

a. Thicker Electrodes Currently Have Lower Power and Energy Density

Electrodes used in lithium ion batteries are made by coating foils with slurries, which contain the active material, conductive additives, binders, and solvent. After coating, the coated foil is then dried, and used as battery electrodes. In almost all cases, thin (about 0.001″ thick or less) aluminum foils are used as the cathode current collectors, and thin copper foils (about 0.001 5″ thick or less) are used as the anode collectors.

Using foam as the base conductor to the intercalation active material in the battery system will minimize the distance from particle to conductor. “Intercalation” is an important concept for lithium-ion batteries.

During charge and discharge, lithium ions shuttle back and forth between the anode and cathode. This differs from the covalent bonds formed during charge and discharge in lead-acid batteries, where species form and then unform during the charge/discharge cycle.

Instead, lithium ions move between and into the carbon lattice—slightly expanding it and being held in place by Van der Waals forces. The lithium ion does not form a compound at either electrode. Rather it shuttles back and forth, in what is commonly called a “rocking chair” effect.

So both the anode and cathode material needs to be intercalatable. That is, be able to expand and allow the lithium ion to insert itself, rather like an egg in a nest. Generally, the spaces in an ideal lattice structure are 1.46 angstroms. Using a metal foam brings the conductor much closer to any given particle in the active material—especially if the active material layers are thick—than just using a metal foil.

The conductive metal foam adds weight. But this negative attribute is more than offset by improved performance—higher power, higher discharge energy, improved thermal characteristics, and broader temperature operating characteristics.

b. Thicker Electrodes Bring Higher Resistance

Particle to particle conductivity becomes increasingly important as an electrode becomes thicker. It has been shown all too often that merely making an electrode thick increases the resistance and decreases the rate capability of the cell. Particle-to-particle contact remains good—and in some cycling regimes even improves—with our metal foam electrode design.

In addition, conventional thicker electrodes fail earlier during cycling than do foam-supported electrodes. This is because the foam will resist the migration of active material that occurs during cycling of a plastic electrode. Less migration means less damage to the system, and adds to the length of battery life.

c. Thicker Electrodes Hard to Make

One practical barrier to the use of thicker electrodes is simply the fabrication method employed. There is a limit to the thickness of a coating that can be applied to a foil and uniformly dried. Just like painting a wall, where the use of too heavy a coating will lead to runs, drips, streaking, and a generally poor finish.

Another barrier is the handling of the electrode materials after coating. The use of multiple “coat and dry” steps would lead to a reasonably uniform electrode. But the associated processing costs would be high, while the physical handling characteristics would be relatively poor.

The quantity of binder used in the electrodes (typically about 5%) is simply too low to give high levels of mechanical integrity. Lower levels of binder would be better, but mechanical integrity (particle to particle contact) wanes with the mechanical forces occurring during the charge/discharge cycling.

Higher levels of binder would improve the situation, but at the cost of compromising electrochemical performance. Further, very thick coatings on foils (say 0.015 to 0.030 inches per side) often crack or delaminate (the layers fall come apart) while the battery is being made.

2. The Solution—Metal Foam (or Other 3D Material) Allows Thicker Electrode

a. Metal Foam Allows Thicker Electrode, Bringing Higher Power and Energy Density

Chemistry and physics principles create a tradeoff. To get higher power and energy density, you need more active material.

But to get more active material, you generally need more surface area. And that either increases the battery's “footprint”—posing a problem for many applications where space is at a premium—or increases manufacturing costs, or both.

For example, as shown in FIG. 1(b), adding more surface area requires adding more cell layers. Making those layers increases manufacturing complexity, and thus increases manufacturing cost. More cell-to-cell connections also increase manufacturing cost, and create more failure points that decrease reliability. Finally, the more cell layers, the more volume in a given battery volume that goes to cell packaging, which is not active material. So adding layers starts to detract from energy and power density.

Using nanostructures (such as carbon nanotubes) can greatly increase the effective surface area of a relatively thin battery. For example, a 1 cm² thin film battery when coated with the nanotubes has an effective surface area of about 50,000 cm². That compares with an effective surface area of 2,000 cm² using the best of the other techniquest available.

That increase in effective surface area gives great power and energy density. But it also costs a great deal. Nanotubes cost hundreds, if not thousands, of times more than the materials we use today. While those costs may drop some, the complexity of the structure will always keep the costs high. Increased surface area also speeds up degradation of the material through surface reactions.

Better to add more active material by making the battery electrodes thicker. In other words, increase the volume rather than the surface area. And increase the amount of effective material in an inexpensive way, simply by adding a thicker layer of the active material. That will always be much less expensive, and more reliable, than adding some complex structure like thousands of very thin layers or billions of nanotubes.

But thicker electrodes increase resistance, and that causes a problem. And a big restriction on battery efficiency has been the lack of interface area between the active chemistry and the electrodes.

For example, the chemistry of lead acid batteries suggests that a theoretical limit on energy density of about 170 Whr/kg. Battery chemistry and physics prevent any higher energy density. Yet lead acid batteries average only about 15-30 Whr/kg, far from the theoretical limit.

Up to now, adding active material to a battery required increasing the surface area. But as noted above, that is not the best solution. Adding active material to a battery by increasing the thickness of the electrodes—while avoiding increased resistance and ensuring that there is plenty of interface area between the active chemistry and the electrodes—is a much better solution. As described below, that can be done with a lithium-based battery by using metal foam (or some other three-dimensional, fillable material) in its electrodes.

b. Metal Foam Prevents Increased Resistance

Using a foam should allow thicker electrodes while minimizing the individual particle-to-conductive-substrate resistance. This is similar to that of a commercial nickel electrode used in a rechargeable nickel metal hydride battery. Even with a thick layer of active material, any given particle in the active material will still be quite close to a part of the conductive foam. The path from particle to conductor will remain small even as the layer's thickness increases. That means no increase in resistance.

3. The Result—Batteries With Higher Power and Energy Density and Lower Cost

Using metal foam (or some other three-dimensional, fillable material) to make thicker battery electrodes can dramatically increase the power and energy density of a battery. For example, we have modeled lithium-ion batteries with gravimetric energy density of 239 Wh/kg, and volumetric energy density of 545 Wh/l. With more experimentation, we believe that even greater energy density can be achieved with our invention.

Thicker electrodes also bring other advantages. For example, most, if not all, lithium ion batteries are made by winding electrode/separator strips around a mandrel. Even the very small ones found in cell phones are made this way. This generally means that, for more capacity, you end up with longer electrode strips.

One problem is this. Along the strips you will get voltage drops. Those voltage drops cause problems because lithium-ion batteries are extremely voltage sensitive. If the voltage is not uniform from cell to cell, and uniform within single cells, a battery can start to perform poorly, or even fail.

Today, this voltage uniformity problem is usually addressed by using multiple “taps” along the strip. But this makes the cell assembly process more complicated, requiring multiple spot welds for each electrode.

With our invention, we use thicker electrodes. All other things being equal, thicker electrodes means shorter strips. This means simpler fabrication—thus cutting costs—and a more reliable cell (due to fewer problems from the voltage drop issue).

### THE DRAWINGS

The drawings show various aspects of examples of batteries with electrodes made with a three-dimensional, fillable material. A brief description of each drawing follows:

FIG. 1(a) shows a cross-section of an example of our battery with two filled, metal foam electrodes and a separator, while FIG. 1(b) shows a cross-section of an example of a competitive battery with several layers of complex construction.

FIG. 2 shows another view of the example battery of FIG. 1(a).

FIG. 3 shows an example of a foil that has been made fillable by punching small holes in it.

FIG. 4 shows C/3 discharge of the example battery of FIG. 1(a).

FIG. 5 shows electrolyte concentration during C/3 discharge.

FIG. 6 shows 2 C-rate pulse discharges 1 minute followed by 5 minute rest.

FIG. 7 shows electrolyte concentration gradient during 2C pulses 1 minute/5 minute rest.

FIG. 8 shows 25% LEO cycling.

FIG. 9 shows electrolyte concentration during 25% LEO cycling.

### DETAILED SPECIFICATIONS ON HOW TO MAKE BATTERIES WITH ELECTRODES WITH THREE-DIMENSIONAL, FILLABLE MATERIAL

### Example A

A Battery With Metal Foam Electrodes

One example of our invention is a high energy/high power lithium ion design which would also be appropriate for lithium polymer and other lithium electrode systems. Using a basic battery design model demonstrates the feasibility of this design. But even better performance than this model indicates should be possible.

The cell in this model will discharge at C/3, and will not become salt-depleted in the electrolyte during discharge.

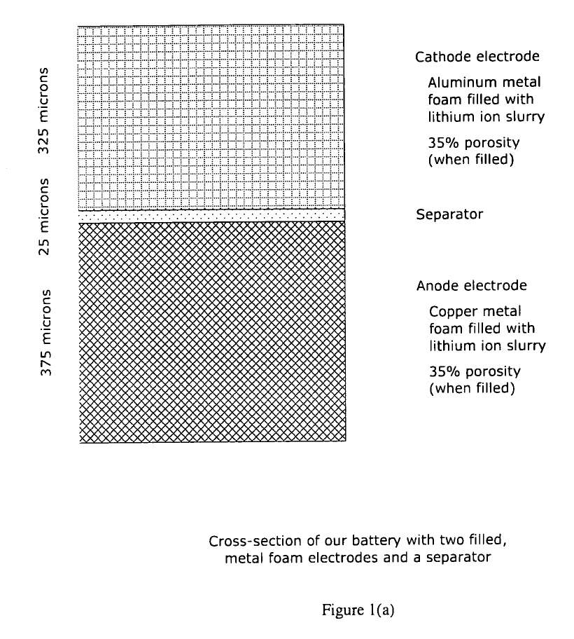

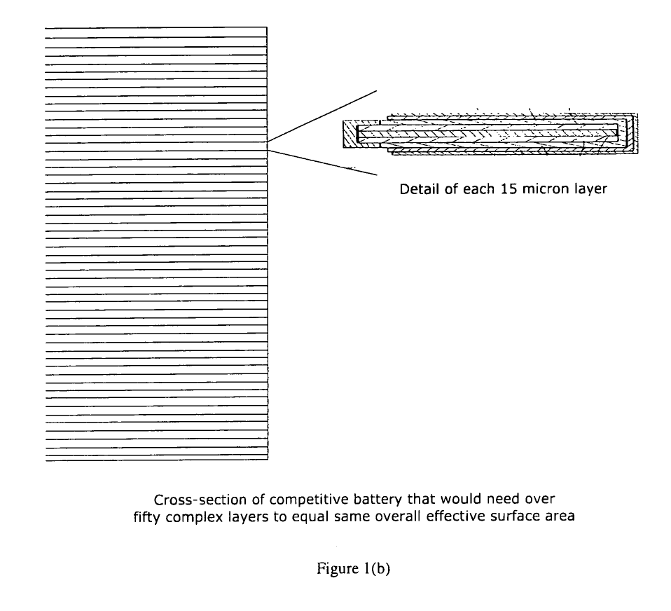

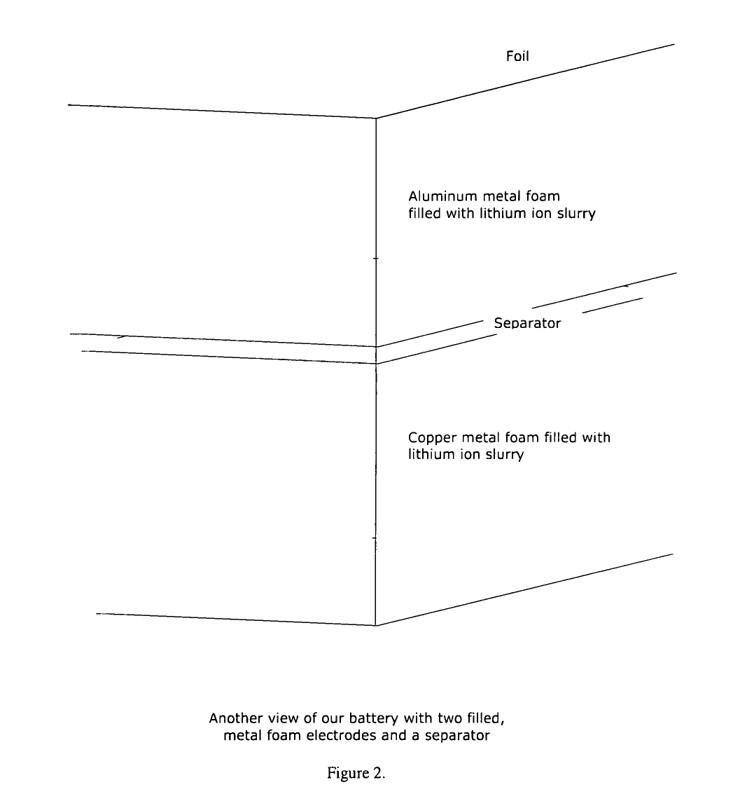

As shown in FIG. 1(a), the model parameters were:
Negative electrode
   Thickness 325 microns (12.8 mil)
   Porosity 35% (after filling)
Separator
   Thickness 25 microns (1 mil)
Positive electrode
   Thickness 375 microns (14.7 mil)
   Porosity 35% (after filling)

These thickness were used for the symmetry plane in both electrodes, since in a prismatic cell (like nickel foams), each face of the electrode “sees” an adjacent plate. Therefore, the design electrode thicknesses would be 2×: negative 25.5 mil, and positive 29.4 mil.

The materials selected were MCMB 2528 graphite, and LiCoO2.

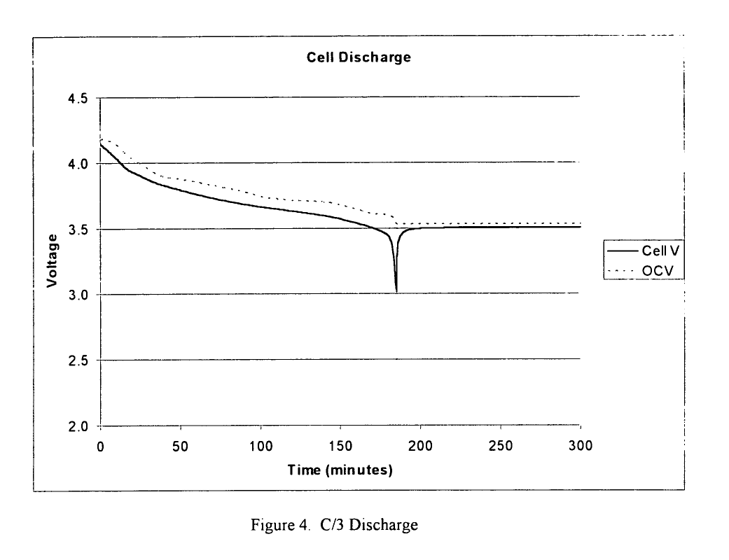

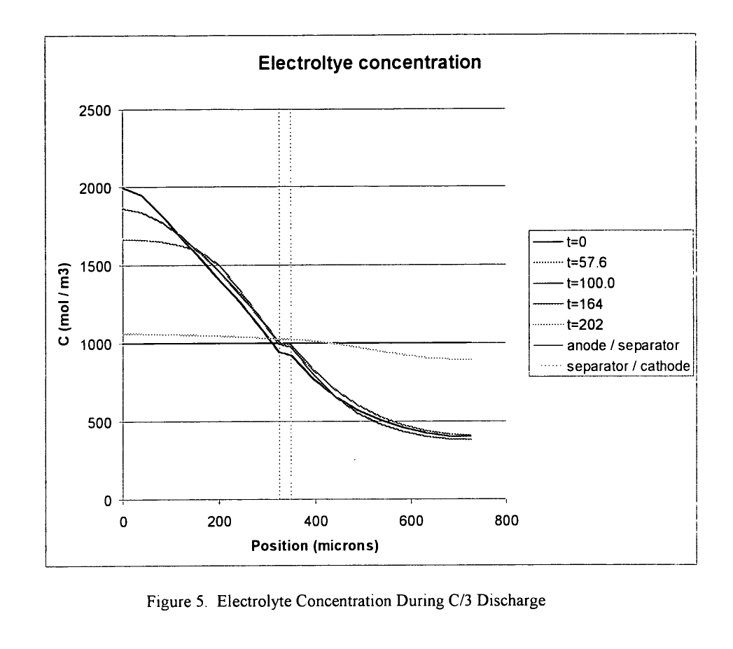

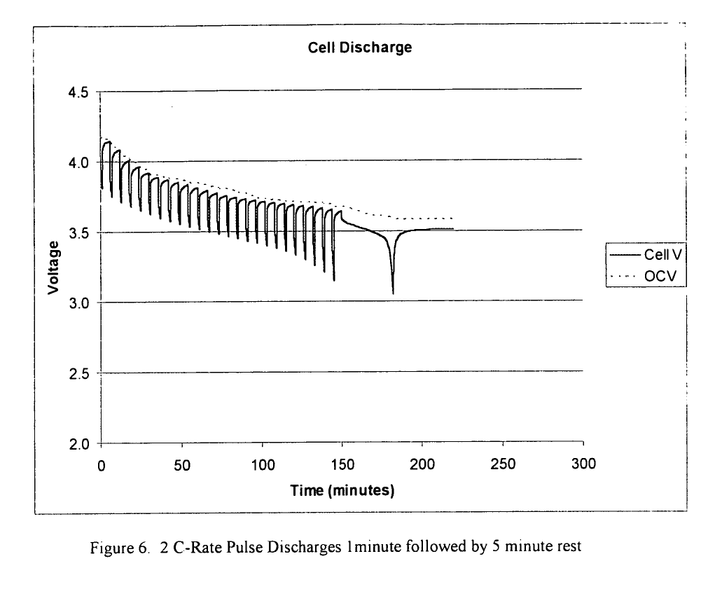

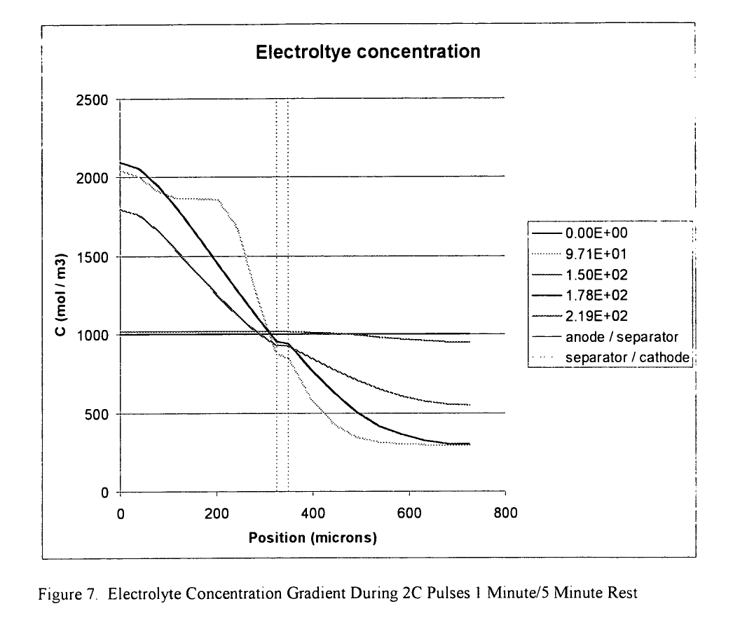

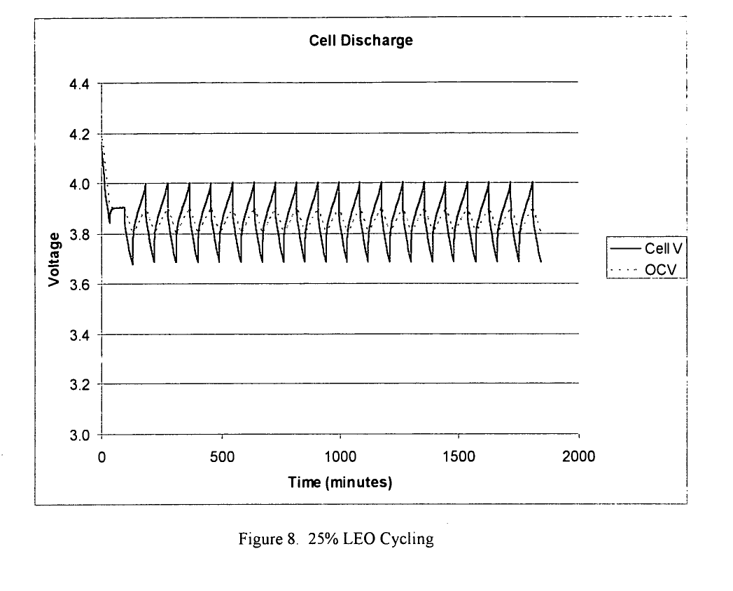

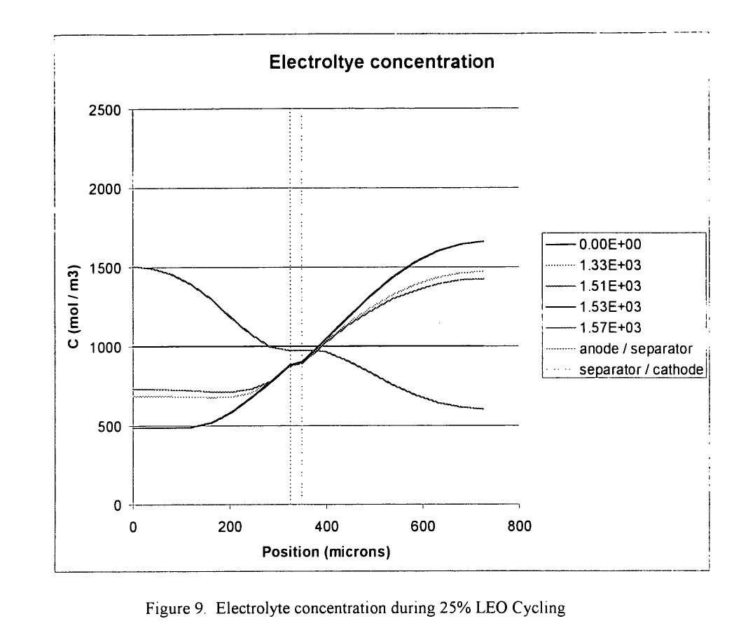

This model predicts an energy density of 230 Wh/kg at a C/3 rate as shown in FIG. 4. Those results come just from an initial model. Tinkering with parameters and building prototypes will bring the numbers up quite a bit. Also, you may be able to “crank” a lot more amps and amp hours for a cell using a metal foam-type electrode than using a coated-foil electrode, with similar improvements in manufacturing throughput.

Based on our simulation results, you can make a pack with 10 positive plates and 11 negative plates. If you take an electrode area of 3″×5″, you get L=5″, W=3″, T=0.6″, Weight=335 g, Vol=0.147 L, Capacity=21.8 Ah (at C/3), Energy=80 Wh, Gravimetric energy density=239 Wh/kg, Volumetric energy density=545 Wh/L.

The volumetric number, especially, represents massive energy density.

We performed a few more simulations to try to predict what other jobs the thick cell as outlined before might be able to do. The material parameters of the cell are all the same, and only the electrical duty cycle was changed.

This duty cycle would be equivalent to a 3-hour total discharge time. The design can do some relatively high power pulsing discharges. But to do that, the overall run time needs to be high enough to prevent concentration problems in the electrodes.

Making an electrode with metal foam or other three-dimensional material begins by choosing the material. For a metal foam, a porosity between 90% and 94% works best. A metal foam of 93% porosity gives plenty of conductivity without adding too much weight. A foam of lower porosity will usually give more conductivity than needed. Compared to foams with higher porosity, a foam with lower than 90% porosity just adds weight without increasing performance.

The choice of the active material for the electrode may also guide the choice of the metal foam or other three-dimensional material. The active material for an anode electrode can be a carbon (including mesobead, spherical, PAN-based or irregular shaped) or a lithium (metal or a solution).

We will describe use of a carbon-based material, but a lithium-metal material can also be used. The active material for the cathode electrode will typically be cobalt oxide, manganese oxide, nickel oxide, or one of the cobalt nickel oxides.

Once the materials are chosen, the foam or other material for the electrode needs to be free of organic oils and other contaminates. Contaminants can degrade conductivity. Too low conductivity can degrade performance.

To prepare the active material for lithium ion electrodes, a Kynar™ binder can be dissolved into a solvent such as NMP. That becomes the vehicle for the active material. About 3 to 7% Kynar will be plenty to keep the electrode together for processing. The less binder that can be used and still have the electrode hold together, the better. A solution of 0.5 to 4% binder works better. Best is 1% or less.

We then add our chosen active material to the dissolved Kynar solution. We can also add a conductive carbon. That is commonly done to increase conductivity from particle to particle within the material, and thus improve performance. Most electrodes use from 5 to 12% conductive carbon to aid in interparticle conductivity. With our metal foam electrodes, adding about 0 to 5% conductive carbon to the active material will give best results. We then thoroughly wet the mixture.

Once clean, the metal foam can be filled with the active material. Several methods can be used to do this—doctor blade, dual doctor or wiper blade, or extruding the active material from a fixed nozzle (the latter method probably works best).

Filling speeds can vary. In general, process speed has little to no impact on performance. But faster processing usually needs more expensive equipment. Slower processing typically costs less.

When filling the metal foam, care must be taken to make sure all the voids are filled. The goal of the application is to fill all the void volume of the substrate with active material. All fluids used to apply the active material, or to make it flow more easily, must be removed once the metal foam has been filled.

Finally, we coin or compress the electrode to its final thickness. If a solid current collector is applied to one side of the foam—such as would be the case in an electrode for a bipolar cell design—the foam can be filled by applying the active material only to one side of the foam.

### Example B

A Battery With Metal Cloth Electrodes

Metal cloth can also be used to increase the thickness of the battery electrodes without increasing resistance. As with the metal foam, the electrode is formed by infusing the metal or carbon cloth (both woven and non-woven can be used) with a slurry containing the active materials of the electrode.

### Example C

A Battery With Perforated Foil Electrodes

As mentioned above, the volume of an electrode can be increased by simply increasing the thickness of the slurry coating applied to it. But thicker coatings have a tendency to crack.

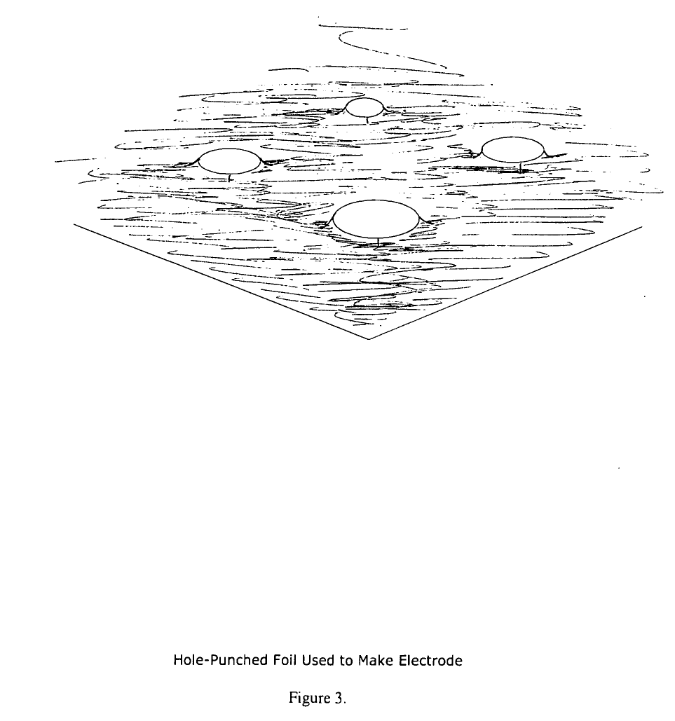

Punching small holes in a foil gives more of a three-dimensional shape to the foil, creating small valleys between the punched holes. Filling the valleys with paste will result in less tendency to crack and give a thicker uniform layer. FIG. 3 shows an example of this.

There are many examples of three-dimensional, fillable materials or shapes that can be used to create thicker battery electrodes. This detailed description of lithium-based batteries with thicker electrodes gives several examples. This invention should not be considered limited to these or any other example.

We claim:

1. A lithium-based battery with at least one electrode made with a three-dimensional, fillable material or shape.

2. A method of making a lithium-based battery with the steps of:
(a) making at least one electrode of a three-dimensional, fillable material or shape,
(b) infusing the material or shape with active battery material.

3. The lithium battery of claim 1 where the battery is of a prismatic, wound, bipolar, or pseudo-bipolar design.

4. The lithium battery of claim 1 for use in a flexible or conformal battery.

5. The lithium battery of claim 1 for use in an RFID or microelectronics application.

6. The lithium battery of claim 1 where the three-dimensional, fillable material is a metal foam.

7. The lithium battery of claim 1 where the three-dimensional, fillable material is a metal cloth.

8. The lithium battery of claim 1 where the three-dimensional, fillable material is a perforated metal foil.
